(19) United States
(12) Patent Application Publication
(10) Pub. No.: US 2025/0033577 A1
(43) Pub. Date: Jan. 30, 2025

(54) STRUCTURE OF A QUADRANT COVER

(71) Applicants: HYUNDAI MOTOR COMPANY, Seoul (KR); KIA CORPORATION, Seoul (KR)

(72) Inventors: Nak Kyoung Kong, Seongnam-si (KR); Sang Heon Wang, Hwaseong-si (KR); Kyung Hwan Kim, Seoul (KR)

(73) Assignees: HYUNDAI MOTOR COMPANY, Seoul (KR); KIA CORPORATION, Seoul (KR)

(21) Appl. No.: 18/534,057

(22) Filed: Dec. 8, 2023

(30) Foreign Application Priority Data
Jul. 24, 2023 (KR) 10-2023-0095711

(51) Int. Cl. B60R 13/04; B60J 5/04; B60R 13/07

(52) U.S. Cl. CPC B60R 13/04; B60J 5/0404; B60R 13/07

(57) ABSTRACT

A structure of a quadrant cover of a vehicle includes an A-pillar positioned without a step difference with a windshield glass, a quadrant cover adjacent to the A-pillar and fixed to a front door, and a rain gutter positioned on the quadrant cover. The rain gutter includes a first rain gutter positioned adjacent to the A-pillar and a second rain gutter positioned to be spaced apart from the A-pillar.

### CROSS-REFERENCE TO RELATED APPLICATION

This application claims under 35 U.S.C. § 119(a) the benefit of priority to Korean Patent Application No. 10-2023-0095711 filed on Jul. 24, 2023, the entire contents of which are incorporated herein by reference.

### BACKGROUND

### (a) Technical Field

The present disclosure relates to a structure of a quadrant cover, and more particularly, to a structure of a quadrant cover for preventing rainwater or washer fluid from flowing onto a front door in a vehicle in which a step difference is not present between a windshield glass and an A-pillar.

### (b) Background Art

A quadrant cover is a component mounted on a front door side of a vehicle and functions to enhance the interior beauty of the vehicle by covering a portion in which a side mirror and a panel frame of a door are coupled. One side of the quadrant cover is coupled to the panel frame of the door. The other side of the quadrant cover is coupled to a door frame molding and the like and fixed to the front door.

Meanwhile, the door frame molding is designed to have various shapes of curves. As described above, when the door frame molding is curved, a process of pre-assembling the door frame molding to the panel frame and then assembling the quadrant cover is included.

Furthermore, rainwater or a washer fluid has been prevented from flowing onto the front door side using a step difference between the windshield glass and the A-pillar.

Recently, vehicles are being manufactured in the form of a smooth exterior shape without a step difference between an outer surface of a front windshield glass and an A-pillar. Thus, there is a problem in that washer fluid sprayed onto the windshield glass or rainwater flows onto the front door due to air flow from driving the vehicle or the like according to the shape without the step difference. The vision of the side mirror is blocked or inhibited thereby.

Therefore, in the case of a vehicle without the step difference between the windshield glass and the A-pillar, it is essential to prevent contamination resulting from rainwater or washer fluid flowing onto the front door along a front surface of the vehicle.

### SUMMARY OF THE DISCLOSURE

The present disclosure has been made in efforts to solve the above noted problems. The present disclosure is directed to providing a structure of a quadrant cover including a rain gutter for blocking fluid from flowing onto a front door in a vehicle that does not have a step difference between the windshield glass and the A-pillar.

In addition, the present disclosure is directed to providing a structure of a quadrant cover including character lines of various shapes formed between a plurality of rain gutters.

Objects of the present disclosure are not limited to the above-described objects. Other objects that are not mentioned can be understood by the following description and more clearly known by embodiments of the present disclosure. In addition, the objects of the present disclosure may be achieved by means described in the claims and combinations thereof.

In order to achieve the objects of the present disclosure, a structure of a quadrant cover includes the following configuration.

The present disclosure relates to a structure of a quadrant cover and provides the structure of the quadrant cover including an A-pillar of a vehicle positioned without a step difference with a windshield glass. The structure in one embodiment includes a quadrant cover adjacent to the A-pillar and fixed to a front door. The structure also includes a gutter feature positioned on the quadrant cover. The gutter feature includes a first gutter positioned adjacent to the A-pillar and a second gutter positioned to be spaced apart from the A-pillar.

In addition, the structure of the quadrant cover may further include a character line or surface contour of an outer surface positioned between the first gutter and the second gutter.

In addition, the character line or contoured surface may be configured to have a height change of 5 mm to 10 mm in a width direction of the vehicle across the quadrant cover.

In addition, the character line or surface contour may be configured to protrude to have a curvature in a width direction of the vehicle across the quadrant cover.

In addition, an upper end of the first gutter and an upper end of the second gutter may be configured to be fastened to a door frame molding of the front door.

In addition, the first gutter and the second gutter may protrude to have a height of at least 5 mm in a width direction of the vehicle relative to the outer surface of the quadrant cover.

In addition, the first gutter and the second gutter may be configured to protrude an amount in the width direction of the vehicle that decreases in a height direction of the vehicle.

Another embodiment of the present disclosure provides a structure of a quadrant cover including an A-pillar of a vehicle positioned without a step difference with a windshield glass. The structure includes a quadrant cover adjacent to the A-pillar and fixed to a front door of the vehicle. The structure also includes a gutter feature positioned on the quadrant cover. The gutter feature includes a first gutter positioned adjacent to the A-pillar and a second gutter positioned to be spaced apart from the A-pillar.

In addition, the structure of the quadrant cover may further include a character line or surface contour on an outer surface positioned between the first gutter and the second gutter.

In addition, the character line or contour surface may be configured to have a height change of 5 mm to 10 mm in a width direction of a vehicle across the quadrant cover.

In addition, the character line or contoured surface may be configured to protrude to have a curvature in a width direction of a vehicle across the quadrant cover.

In addition, an upper end of the first gutter and an upper end of the second gutter may be configured to be connected to a door frame molding of the front door.

In addition, the protruding first gutter and second gutter may have a height of at least 5 mm in the width direction of the vehicle relative to the outer surface of the quadrant cover.

In addition, the first gutter and the second gutter may be configured to protrude an amount in the width direction of the vehicle that decreases in a height direction of the vehicle.

The present disclosure can obtain the following effects by the above-described embodiments and by configurations and embodiments, which are described below.

According to the present disclosure, it is possible to control the flow of fluid flowing onto the front door along the A-pillar by providing the structure of the quadrant cover including two rain gutters.

In addition, according to the present disclosure, it is possible to improve the visibility of the side mirror by controlling the fluid flowing onto the front door.

In addition, according to the present disclosure, the two rain gutters can be fastened to the door frame molding to guide the fluid flowing onto the front door. Therefore, it is possible to prevent rainwater or washer fluid from flowing onto the front door and door window glass, thereby improving visibility and vehicle driving stability.

It is understood that the terms “automotive” or “vehicular” or other similar terms as used herein are inclusive of motor vehicles in general. Such motor vehicles may encompass passenger automobiles including sports utility vehicles (SUV), buses, trucks, various commercial vehicles, watercraft including a variety of boats and ships, aircraft, and the like. Such vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example a vehicle that is both gasoline-powered and electric-powered.

The above and other features of the disclosure are discussed below.

### BRIEF DESCRIPTION OF THE DRAWINGS

The above and other features of the present disclosure will now be described in detail with reference to certain examples thereof illustrated in the accompanying drawings which are given herein below by way of illustration only, and thus are not limitative of the present disclosure, and wherein:

FIG. 1 is a view illustrating an installed relationship between a windshield glass and an A-pillar according to one embodiment of the present disclosure;

FIG. 2 is a configuration diagram of a quadrant cover including a rain gutter feature according to one embodiment of the present disclosure;

FIG. 3 is a configuration diagram of the quadrant cover including a character line having an inclined cross section according to one embodiment of the present disclosure; and

FIG. 4 is a configuration diagram of the quadrant cover including a character line having a curved cross section according to one embodiment of the present disclosure.

It should be understood that the appended drawings are not necessarily drawn to scale, presenting a somewhat simplified representation of various features illustrative of the basic principles of the disclosure. The specific design features of the present disclosure as shown and described herein, including, for example, specific dimensions, orientations, locations, and shapes will be determined in part by the particular intended application and use environment.

In the figures, the same reference numbers refer to the same or equivalent parts of the present disclosure throughout the several figures of the drawings.

### DETAILED DESCRIPTION

Hereinafter, embodiments of the present disclosure are described in more detail with reference to the accompanying drawings. The embodiments of the present disclosure may be modified in various forms, and the scope of the present disclosure should not be construed as being limited to the following embodiments. The embodiments are provided to more completely describe the present disclosure to those having ordinary skill in the art.

In addition, terms such as “ . . . part,” “ . . . filler,” and “ . . . trim” described in the specification mean a unit that performs at least one function or operation, which may be implemented by a single piece of hardware or a coupling of multiple hardware pieces.

In addition, the terms used in the specification are only used to describe specific embodiments and are not intended to limit the embodiments. The singular expression includes the plural expression unless the context clearly dictates otherwise.

In addition, in this specification, names of components may be classified as first, second, etc., in order to identify and distinguish among components that are the same, and the order is not necessarily limited by such terms in the following description. When a component, device, element, or the like of the present disclosure is described as having a purpose or performing an operation, function, or the like, the component, device, or element should be considered herein as being “configured to” meet that purpose or perform that operation or function.

In addition, when a direction of an aspect of the configuration in this specification is referred to as a “height” direction or a “width” direction, it may be construed as meaning a height direction and a left-right width direction of a vehicle based on the normal stance of the vehicle.

Hereinafter, embodiments are described in detail with reference to the accompanying drawings. In describing the embodiments with reference to the accompanying drawings, the same or corresponding components are denoted by the same reference numerals and overlapping or repetitive descriptions thereof have been omitted.

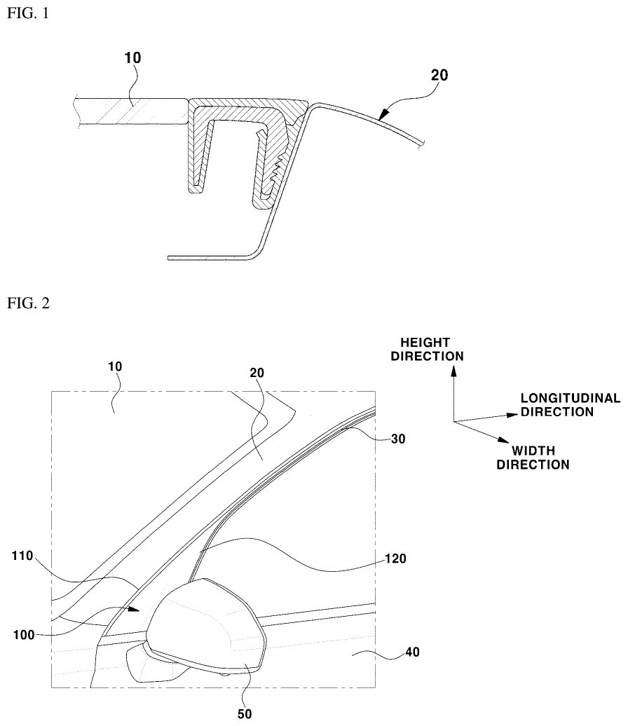

FIG. 1 illustrates a cross section between a front windshield glass 10 and an A-pillar 20 installed on a vehicle.

As illustrated, the vehicle has a quadrant cover 100 according to the present disclosure positioned and configured in a state in which there is no step difference between the windshield glass 10 and the A-pillar 20. In other words, as shown in FIG. 1, the exterior surfaces of the A-pillar 20 and the windshield glass 10 are flush with one another with no step or height difference. With this configuration, a washer fluid sprayed onto the front windshield glass 10 or rainwater hitting the windshield glass 10 flows onto a door glass along the A-pillar 20. Therefore, there is a problem in that the visibility of a side mirror 50 is obscured, hindered, or inhibited, i.e., reduced. As a result, the quadrant cover 100 includes a gutter feature with a first gutter 110 and a second gutter 120.

FIG. 2 illustrates the front door of the vehicle equipped with the quadrant cover 100 including the gutter feature according to one embodiment of the present disclosure.

The A-pillars 20 are positioned at both sides of the windshield glass 10, respectively, and the front doors are disposed at positions adjacent to the respective A-pillars 20, particularly when the doors are closed. The side mirror 50 is positioned on the front door, and the front door includes a door frame molding 30 configured to surround the door glass.

In addition, the quadrant cover 100 for a vehicle is installed by being fastened to the door frame molding 30. In this case, the quadrant cover 100 may be positioned at a position facing the A-pillar 20. In one example, one side of the quadrant cover 100 is fastened to the door frame molding 30. In other words, the quadrant cover 100 may be disposed in front of the door frame molding 30. Therefore, the quadrant cover 100 may be fixedly fastened to the door frame molding 30 adjacent to the A-pillar 20.

Furthermore, a lower end of the quadrant cover 100 may be fastened to a panel 40 forming a part of the front door. The side mirror and a fastened portion of the panel 40 may be covered to enhance the aesthetic appearance of the vehicle.

As described above, the quadrant cover 100 may be configured to surround a front end of the front door glass at a position adjacent to the side mirror 50 and may be connected to the A-pillar 20 and positioned to protrude or extend rearward by a predetermined interval in a longitudinal direction of the vehicle. Furthermore, the quadrant cover 100 is positioned to cover at least a portion of the front door window glass.

The quadrant cover 100 and the door frame molding 30 may be integrally configured as a unitary structure. Alternatively, the quadrant cover 100 and the door frame molding 30 may be separate component so that an upper end of the quadrant cover 100 is connected to the door frame molding 30.

A front end of the quadrant cover 100 may be configured to extend in a height direction of the vehicle while facing the A-pillar 20. The quadrant cover 100 includes the first gutter 110 positioned at one end, i.e., along one edge of the quadrant cover 100, facing the A-pillar 20. The quadrant cover 100 also includes the second gutter 120 positioned to be spaced apart from the A-pillar 20. In one example, the first gutter 110 is formed along an outer perimeter surface of the front end or edge of the quadrant cover 100. Also, in one example, the second gutter 120 is positioned along an outer perimeter surface of a rear end or edge of the quadrant cover 100.

Furthermore, the first gutter 110 and the second gutter 120 are configured to have a protruding shape in a width direction of the vehicle based on or relative to the outer surface of the quadrant cover 100. In other words, the first and second gutters may protrude outward relative to the outer surface of the quadrant cover 100. Also, the quadrant cover 100 is configured so that an upper end of the first gutter 110 and an upper end of the second gutter 120 become closer to one another in a height direction of the vehicle. In one example, an uppermost end of the quadrant cover 100 at which the first gutter 110 and the second gutter 120 are closest in spacing to one another may be positioned by being fastened to the door frame molding 30.

In one embodiment of the present disclosure, the first gutter 110 or/and the second gutter 120 are configured to protrude by at least 5 mm based on or relative to the adjacent outer surface of the quadrant cover 100 and may be configured so that protrusion is relatively reduced, i.e., the protrusion height decreases, toward the upper end of the quadrant cover 100. Moreover, the first gutter 110 and the second gutter 120 positioned at the uppermost end of the quadrant cover 100, where connected to the door frame molding 30, are configured to form surfaces substantially parallel to, i.e., flush with, the outer surface of the door frame molding 30 in the width direction of the vehicle.

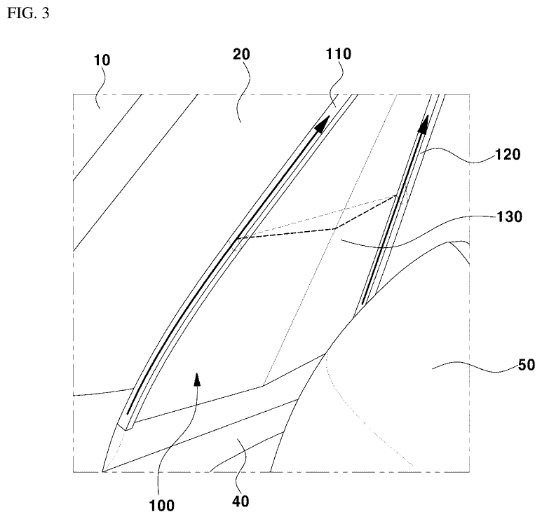

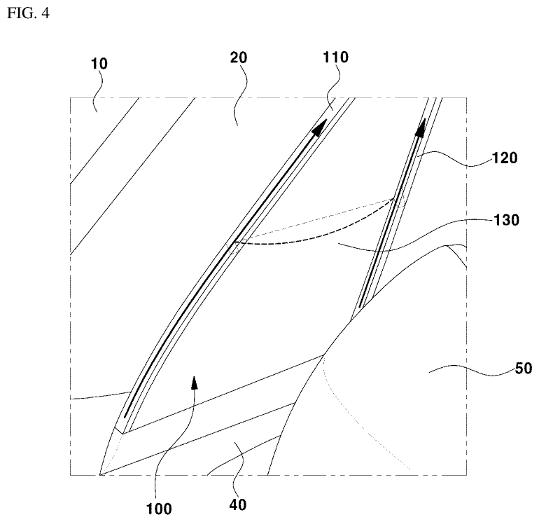

A contoured surface 130 configured to correspond to the shapes of the first gutter 110 and the second gutter 120 may be included between the first gutter 110 and the second gutter 120. The contoured surface 130 may be configured to have a protruding shape in the width direction of the vehicle and based on or such that the outer surface of the quadrant cover 100 is not flat but convex or protruding between the first and second gutters 110, 120. In other words, the contoured surface may be referred to as a character line 130 defining a cross sectional shape between the first and second gutters 110, 120. The contoured surface or character line 130 may be defined as having a peak of the convex or contoured shape of the outer surface between the first and second gutters 110, 120 (shown as the vertically extending dashed line along the quadrant cover 100 in FIGS. 3 and 4).

In one example, a maximum protruding region, i.e., peak height, of the contoured surface or character line 130 may be configured to be located or positioned the same distance between the first gutter 110 and the second gutter 120. The outer surface of the quadrant cover 100 may also be configured so that the protrusion height is reduced toward a position adjacent to each of the first gutter 110 and the second gutter 120.

In addition, the shape of the contoured surface or character line 130 may include an inclined shape from the position adjacent to each of the first gutter 110 and the second gutter 120 and have a peak positioned at the center, i.e., where the two inclined surfaces meet at the vertical dashed line in FIGS. 3 and 4). In addition, as another embodiment, the shape of the contoured surface or character line 130 may be configured to have a sloped cross section toward the first gutter 110 and the second gutter 120 along a central region. The surfaces of the inclined portions or sloped portions may be flat or curved, as desired, and the peak may define a sharp edged peak or a rounded peak.

The contoured surface or character line 130 includes a shape protruding to have a height of 5 mm to 10 mm in the width direction of the vehicle based on the outer surface of the quadrant cover 100. In one example, a maximum protruding height of a maximum protruding region of the outer surface of the quadrant cover 100 is configured to be formed in a range of 5 mm to 10 mm. The height noted herein for the contoured surface or character line 130 may be taken relative to a planar reference line extending between the first and second gutters 110, 120, as shown in FIGS. 3 and 4.

FIG. 3 illustrates a structure of the quadrant cover 100 including the contoured surface or character line 130 having the shape inclined from the first gutter 110 and the second gutter 120 according to one embodiment of the present disclosure, as described above.

As illustrated, the quadrant cover 100 is positioned adjacent to the A-pillar 20 and installed and positioned by being fastened to the door panel 40 in which the side mirror 50 is positioned. Furthermore, the quadrant cover 100 is configured to have a narrower width in the longitudinal or rearward extending direction of the vehicle toward the upper end relative to the lower end fastened to the door panel 40. The uppermost end of the quadrant cover 100 is configured to be fastened to the door frame molding 30.

The contoured surface or character line 130 is configured in an inclined shape to protrude from the first gutter 110 and the second gutter 120 in the width direction of the vehicle. A central portion of the contoured surface or character line 130 (the vertical dashed line) has the largest protrusion height and includes a peak region in which a protruding height is formed in a range of 5 mm to 10 mm.

Therefore, when a fluid sprayed onto the windshield glass 10 moves to the door glass along the A-pillar 20, the fluid moves up along the gutter feature of the quadrant cover 100. Specifically, fluid moves up along the first gutter 110 in the height direction of the vehicle. The fluid moved to the second gutter 120 through the contoured surface or character line 130 moves to the uppermost end of the quadrant cover 100 along the second gutter 120. Furthermore, the fluid moving along the first gutter 110 and the second rain gutter 120 is guided or directed to move toward the upper end and the rear of the vehicle along the door frame molding 30 positioned to extend from the uppermost end of the quadrant cover 100.

In one example, a turbulence region, created by air flow as the vehicle is driven or travels, is formed in the door frame molding 30 fastened to the uppermost ends of the first gutter 110 and the second gutter 120. The fluid moving to the upper end of the quadrant cover 100 along the first gutter 110 and the second gutter 120 is thus drained along the upper end of the door glass.

FIG. 4 illustrates the quadrant cover 100 configured so that the contoured outer surface or character line 130 has a curved shape according to another embodiment of the present disclosure.

The quadrant cover 100 is positioned by being fastened to the door panel 40 adjacent to the side mirror 50 and includes the first gutter 110 positioned on the outer perimeter surface or forward edge of the quadrant cover 100 adjacent to the A-pillar 20 and the second gutter 120 positioned on the outer perimeter surface or rear edge of the quadrant cover 100 spaced apart from the A-pillar 20.

In this example, the contoured surface or character line 130 is positioned between the first gutter 110 and the second gutter 120 and a cross section of the character line 130 is formed in a curved shape protruding in the width direction of the vehicle based on the outer surface of the quadrant cover 100.

In one example, the illustrated cross section of the quadrant cover 100 is described. The first gutter 110 and the second gutter 120 are configured to have a protruding shape based on the outer surface of the quadrant cover 100. The contoured surface or character line 130 is configured to have a maximum protrusion in the central region in a curved shape between inner ends of the first gutter 110 and the second gutter 120 facing each other.

Therefore, the fluid moving along the windshield glass 10 and the A-pillar 20 is configured to be drained after flowing to the upper portion of the door glass through the first gutter 110, the countered surface or character line 130, and the second gutter 120.

The above detailed description is illustrative of the present disclosure. In addition, the above-described contents are intended to illustrate and describe various embodiments of the present disclosure. The embodiments of the present disclosure can be used in various other combinations, modifications, and environments. In other words, changes or modifications are possible without departing from the scope of the concept of the disclosure disclosed in the specification, the scope equivalent to the disclosed contents, and/or the scope of ordinary skill or knowledge in the art. The disclosed embodiments describe examples for implementing the technical spirit of the present disclosure, and various changes required in specific application fields and uses of the present disclosure are also possible. Therefore, the above detailed description of the disclosure is not intended to limit the present disclosure to the disclosed embodiments. In addition, the appended claims should be construed to include other embodiments as well.

What is claimed is:

1. A structure of a quadrant cover of a vehicle, the structure comprising:
an A-pillar positioned and configured without a step difference with an adjacent windshield glass;
a quadrant cover adjacent to the A-pillar and fixed to a front door; and
a gutter feature positioned on the quadrant cover,
wherein the gutter feature includes a first gutter positioned adjacent to the A-pillar and a second gutter positioned to be spaced apart from the A-pillar.

2. The structure of claim 1, further comprising a surface contour on an outer surface positioned between the first gutter and the second gutter.

3. The structure of claim 2, wherein the surface contour is configured to have a change in height of 5 mm to 10 mm in a width direction of a vehicle across the quadrant cover.

4. The structure of claim 2, wherein the surface contour is configured to protrude to have a curvature in a width direction of a vehicle across the quadrant cover.

5. The structure of claim 1, wherein an upper end of the first gutter and an upper end of the second gutter are configured to be fastened to a door frame molding of the front door.

6. The structure of claim 1, wherein the first gutter and the second gutter protrude to have a height of at least 5 mm in a width direction of a vehicle relative to the outer surface of the quadrant cover.

7. The structure of claim 6, wherein the first gutter and the second gutter are configured to protrude an amount in the width direction of the vehicle that decreases in a height direction of the vehicle.

8. A structure of a quadrant cover of a vehicle, the structure comprising:
an A-pillar positioned without a step difference with a windshield glass;
a quadrant cover adjacent to the A-pillar and fixed to a front door; and
a gutter feature positioned on the quadrant cover,
wherein the gutter feature includes
a first gutter positioned adjacent to the A-pillar and protruding in a width direction of the vehicle, and
a second gutter positioned to be spaced apart from the A-pillar and protruding in the width direction of the vehicle.

9. The structure of claim 8, further comprising a surface contour of an outer surface positioned between the first gutter and the second gutter.

10. The structure of claim 9, wherein the surface contour is configured to have a change in height of 5 mm to 10 mm in the width direction of the vehicle across the quadrant cover.

11. The structure of claim 9, wherein the surface contour is configured to protrude to have a convex curvature in the width direction of the vehicle across the quadrant cover.

12. The structure of claim 8, wherein an upper end of the first gutter and an upper end of the second gutter are configured to be connected to a door frame molding of the front door.

13. The structure of claim 8, wherein the protruding first gutter and second gutter have a height of at least 5 mm in the width direction of the vehicle relative to the outer surface of the quadrant cover.

14. The structure of claim 13, wherein the first gutter and the second gutter are configured to protrude an amount in the width direction of the vehicle that decreases in a height direction of the vehicle.
